(19) United States
(12) Patent Application Publication
(10) Pub. No.: US 2009/0297659 A1
(43) Pub. Date: Dec. 3, 2009

(54) ENZYMATIC DOUGH CONDITIONER AND FLAVOR IMPROVER FOR BAKERY PRODUCTS

(76) Inventors: Troy T. Boutte, Overland Park, KS (US); Kathryn L. Sargent, Edwardsville, KS (US); Guohua Feng, Lenexa, KS (US)

Correspondence Address: HOVEY WILLIAMS LLP, 10801 Mastin Blvd., Suite 1000, Overland Park, KS, 66210, US

(21) Appl. No.: 12/132,380

(22) Filed: Jun. 3, 2008

(51) Int. Cl. A21D 8/04; A21D 10/00

(52) U.S. Cl. 426/18; 426/549

(57) ABSTRACT

Novel yeast-raised and other bakery products and methods of making those products are provided. The products are formed from dough comprising very high levels of maltogenic amylase. These levels result in improved properties in the final baked product, including improved flavor, longer shelf life, and higher baked volumes. In one embodiment, the level of sugar included in the dough can be substantially reduced compared to prior art quantities, while still achieving a sweet product. The invention also allows certain chemicals such as sodium stearoyl lactylate and azodicarbonamide to be entirely eliminated from the dough.

### BACKGROUND OF THE INVENTION

1. Field of the Invention

The present invention is broadly concerned with novel bakery products having exceptionally long shelf lives, greatly improved flavor profiles throughout these shelf lives, significantly higher baked volume, and other advantageous properties. The invention is also directed towards novel methods of making such bakery products using high quantities of maltogenic amylase. Furthermore, these properties can be achieved even without the use of chemical additives.

2. Description of the Prior Art

There are several mechanisms by which dough strengthening occurs, including covalent cross-linking of wheat proteins, redistribution of water from fiber to protein, coating of starch with emulsifiers, starch complexing, protein complexing, and viscosity control. Covalent cross-linking occurs when various classes of proteins are oxidized to form cross-links resulting in a protein network referred to as gluten. Several other types of covalent and non-covalent cross-links can form, including disulfide bonds, dityrosine bonds, hydrophobic bonds, ionic bonds, and bonds between wheat fiber and protein. The amount and type of cross-links that form can be adjusted by varying the amount and type of the various dough strengtheners used. Closely related to covalent cross-linking is protein complexing, which refers to non-covalent cross-links that form between certain emulsifiers and protein. These cross-links, which are based on ionic and hydrophobic bonds, are complimentary to covalent cross-links.

Redistribution of water from the arabinoxylan fiber portion of dough to the protein portion is achieved by using cellulase or xylanase enzymes. These enzymes break down the fiber, which releases water that can then be transferred to the protein. If the protein is deprived of water, this transfer can result in a strengthening effect as protein requires a certain minimum amount of water to function optimally.

Starch coating and starch complexing is achieved almost exclusively by emulsifiers. Starch coating occurs when an emulsifier adheres to the surface of starch granules during dough mixing, which reduces water uptake by the starch. This increases water availability to protein and also delays gelatinization of starch in the oven, thus reducing viscosity. Starch complexing by emulsifiers occurs when starch granules start to swell and release amylose during the bake. The emulsifier induces the amylose to form an insoluble complex, further reducing viscosity and improving overall volume of the final baked product.

It is also desirable to minimize dough viscosity in the early stages of dough processing so that the amount of mechanical abuse a dough experiences is low. It is also desirable to maintain an optimum viscosity during proofing, which allows the dough to expand freely but with enough structural rigidity to prevent collapse clue to mechanical shock. Lastly, during the baking of the dough piece, it is desirable to decrease dough viscosity to allow for final expansion in the oven. Dough viscosity during the early stages of processing is controlled in a number of ways including altering basic ingredients such as water and sugar and by addition of cellulases, xylanases, proteases, and reducing agents such as L-cysteine or sodium metabisulfite. These additives also work to some extent in the late stages of proofing and early baking, but proteases may also be used to reduce viscosity in the later stages of baking.

All of the prior approaches to dough conditioning are somewhat complementary and can be used concurrently, although there are limitations in all cases. Excessive covalent cross-links can result in dough that is overly strong and tight, resulting in dough that is difficult to shape with poor expansion during proofing and baking. Likewise, non-covalent cross-links can also result in excessively strong dough that can produce misshapen bakery products due to overexpansion. Reduction of dough viscosity by use of L-cysteine, sodium metabisulfite, cellulase, xylanase, and protease can result in dough that is excessively slack and sticky, and therefore difficult to machine resulting in poor final baked characteristics.

Improvement of bread flavor has received much less attention by researchers than dough conditioning. Historically, bread had a very short shelf life of just one to three days, depending on the formulation and process. The main cause of the short shelf life of bread is staling caused by recrystallization of starch gelatinized during the baking process. However, another major result of staling is loss of fresh baked bread flavor. The use of emulsifiers gave bread an additional 2-3 days of shelf life. Later, the use of bacterial amylases resulted in several additional days of shelf life. Eventually, maltogenic amylase was introduced, resulting in the current bread shelf life of about three weeks. However, although current bread formulations may stay relatively soft and moist for 3 weeks, the flavor of the bread deteriorates significantly before that time. Further, crystallizing starch can entrap flavor molecules. The starch does not trap flavor molecules equally, but preferentially entraps non-polar molecules. The flavor of the baked product after starch crystallization is therefore generally of less intensity but can also be very unbalanced. The flavor of stale bread is therefore sometimes described as bitter, acidic, or moldy. In addition, the often negative flavor of certain mold inhibitors can become more pronounced.

There are products sold commercially for improving the flavor of bread products. Some are compounded flavors, the best of which include natural and artificial flavor chemicals to simulate the flavor produced by yeast fermentation. These flavors can be expensive, do not match the flavor of actual yeast fermentations, and require labeling of artificial flavors.

Another approach is to make naturally fermented dough either by lactobacillus or yeast fermentation followed by drying to a powder, which is sold commercially. This approach is even more expensive in use, and the resulting flavor of the bread does not match that of a natural yeast fermentation as the drying process causes a loss of many of the volatile flavor constituents.

Another problem associated with the prior art is the use of sugar. Sugar is used in bread to yield a final bread with a sweet flavor. Sugar has a number of undesirable properties in terms of baking. First, sugar dissolves in water added to the dough, increasing the amount of liquid phase present. Therefore, the dough becomes more wet and sticky unless some water is removed from the dough. Sugar also binds some of the water, making it unavailable for protein network development. As a result, additional dough strengtheners are required to achieve the same gluten development achieved in low-sugar formulations. Above a certain percentage of the formula, sugar also starts to inhibit yeast fermentation, which requires using a higher level of yeast. Excessive sugar, while desirable for flavor, also causes the crust of bread to burn at typical oven temperatures. Therefore, for sweet breads, bakeries typically reduce oven temperatures and increase bake time significantly to achieve proper crust color.

### SUMMARY OF THE INVENTION

The present invention broadly provides a method of forming a yeast-raised bread product. The method comprises providing a dough comprising flour, sugar, and a maltogenic amylase. The sugar is provided in an initial quantity of less than about 5% by weight sugar, based upon the total weight of the flour taken as 100% by weight. The dough is then baked for a time and temperature sufficient to yield the bakery product, which has a maltose level of at least about 5% by weight of the dried solids in the bakery product.

The invention also provides a dough useful for forming a yeast-raised bakery product. The dough comprises flour, yeast, and water, with the improvement being that the dough comprises: less than about 5% by weight sugar, based upon the total weight of the flour taken as 100% by weight; and a maltogenic amylase at levels of at least about 3,000 MANU/kg of flour.

In another embodiment, the dough comprises: less than about 0.15% by weight of each of the following: ethoxylated monoglycerides, DATEM, calcium stearoyl lactylate, and sodium stearoyl lactylate, based upon the total weight of the flour taken as 100% by weight; less than about 15 ppm, based upon the weight of the flour, of each of the following: potassium bromate, potassium iodate, azodicarbonamide, and calcium peroxide; and a maltogenic amylase at levels of at least about 3,000 MANU/kg of flour.

The invention is also directed towards a yeast-raised bakery product formed from flour, yeast, and water. In this embodiment, the improvement is that the product comprises: at least about 500 ppm, based upon the weight of the flour, of inactivated maltogenic amylase; and at least about 5% by weight maltose, based upon the weight of the dried solids in the bakery product.

### BRIEF DESCRIPTION OF THE DRAWINGS

FIG. 1 is a graph depicting the effect of maltogenic amylase on flavor perception;

FIG. 2 is a graph showing the effect of maltogenic amylase on sweetness perception;

FIG. 3 is a graph illustrating the effect of maltogenic amylase on bread texture;

FIG. 4 is a graph showing the effect of maltogenic amylase on the overall acceptability of bread;

FIG. 5 is a graph setting forth the mean volume values of several samples of bread compared to a control;

FIG. 6 is a graph depicting the mean bread crumb compressibility values of several samples of bread compared to a control;

FIG. 7 is a graph illustrating the mean bread crumb adhesive values of several samples of bread compared to a control;

FIG. 8 is a graph showing the softness of bread according to the invention compared to control samples; and

FIG. 9 is a graph depicting the resilience of breads according to the invention compared to control samples.

### DETAILED DESCRIPTION OF THE PREFERRED EMBODIMENTS

In more detail, the present invention is concerned with novel dough formulations as well as novel methods of making yeast-raised bakery products and other bakery products with these formulations. These product include those selected from the group consisting of breads, pretzels, English muffins, buns, rolls, tortillas (both corn and flour), pizza dough, bagels, and crumpets.

In the inventive methods, a plurality of ingredients for the particular product are mixed together. These ingredients and their preferred ranges are set forth in Table 1.

TABLE 1

| | | | MOST |
|---|---|---|---|
| INGREDIENT | BROAD RANGE* | PREFERRED* | PREFERRED* |
| Yeast | from about 1% to | from about 2% to | from about 3% to |
| | about 8% | about 6% | about 4% |
| Dough | from about 0% to | from about 0.25% to | from about 0.35% to |
| Strengthener | about 2% | about 1% | about 0.5% |
| Sugar | from about 0% to | from about 4% to | from about 8% to |
| | about 20% | about 15% | about 12% |
| Dry Milk | from about 0% to | from about 1% to | from about 1% to |
| | about 3% | about 2% | about 1.5% |
| Salt | from about 1% to | from about 1.5% to | from about 1.75% to |
| | about 3% | about 2.5% | about 2.25% |
| Mold Inhibitor | from about 0.1% to | from about 0.2% to | from about 0.25% to |
| | about 0.5% | about 0.4% | about 0.35% |
| Oil/Fat | from about 0% to | from about 1% to | from about 2% to |
| | about 20% | about 6% | about 3% |
| Flour Improver | from about 0 ppm to | from about 10 ppm to | from about 40 ppm |
| | about 500 ppm | about 200 ppm | to about 75 ppm |
| Azodicarbonamide | from about 0 ppm to | from about 10 ppm to | from about 30 ppm |
| | about 45 ppm | about 40 ppm | to about 40 ppm |
| Emulsifiers | from about 0% to | from about 0.5% to | from about 1% to |
| | about 4% | about 3% | about 2.5% |
| Water | from about 50% to | from about 55% to | from about 58% to |
| | about 75% | about 70% | about 65% |
| Bacterial Amylase | at least about 3,000 | from about 5,000 to | from about 5,000 to |
| | MANU/kg flour | about 30,000 | about 10,000 |
| | | MANU/kg flour | MANU/kg flour |
| Other Enzymes | from about 0 ppm to | from about 20 ppm to | from about 100 ppm |
| | about 2,000 ppm | about 300 ppm | to about 200 ppm |

*Percentage by weight or ppm based upon 100 lb. of flour.

The yeast used can be any yeast conventionally used in yeast-raised bakery products, with compressed yeast being preferred. Suitable dough strengtheners include those selected from the group consisting of sodium stearoyl lactylate, ethoxylated monoglyceride, diacetyl tartaric acid esters of mono- and diglycerides (DATEM), and mixtures thereof.

The sugar can be any typical sugar used in bakery products, including sucrose and high-fructose corn syrup.

Preferred mold inhibitors include those selected from the group consisting of calcium propionate, potassium sorbate, vinegar, raisin juice concentrate, and mixtures thereof. The preferred oil or fat is selected from the group consisting of soy oil, partially hydrogenated soy oil, lard, palm oil, corn oil, cottonseed oil, canola oil, and mixtures thereof.

Suitable flour improvers include those selected from the group consisting of ascorbic acid, potassium bromate, potassium iodate, calcium peroxide, and mixtures thereof. While any conventional emulsifier can be utilized, preferred emulsifiers include polyoxyethylene sorbitan monostearate (typically referred to as Polysorbate 60) and monoglycerides, such as hydrated monoglycerides, citrylated monoglycerides, and succinylated monoglycerides.

It is preferred that the bacterial amylase be one that is inactivated between about 80° C. and about 90° C., so that starch degradation occurs up to these temperatures. The most preferred amylase is a maltogenic amylase, more preferably a maltogenic α-amylase, and even more preferably a maltogenic α-exoamylase. The most preferred such amylase is sold under the name NOVAMYL by Novozymes A/S and is described in U.S. Pat. No. RE38,507, incorporated by reference herein. This maltogenic amylase is producible by Bacillus strain NCIB 11837, or one encoded by a DNA sequence derived from Bacillus strain NCIB 11837 (the maltogenic amylase is disclosed in U.S. Pat. No. 4,598,048 and U.S. Pat. No. 4,604,355, the contents of which are incorporated herein by reference). Another maltogenic amylase which may be used in the present process is a maltogenic β-amylase, producible by Bacillus strain NCIB 11608 (disclosed in EP 234 858, the contents of which are hereby incorporated by reference).

Some of the other enzymes that can be included in the invention in addition to the maltogenic amylase include those selected from the group consisting of fungal amylases, hemi-cellulases, xylanases, proteases, glucose oxidase, hexose oxidase, lipase, phospholipase, asparaginase, and cellulases.

The maltogenic amylase is included at very high levels compared to previous products. In this embodiment, the amylase is included at levels of at least about 500 ppm, preferably from about 750 ppm to about 4,000 ppm, more preferably from about 1,500 ppm to about 3,500 ppm, and even more preferably from about 2,500 to about 3,000 ppm, based upon 100 lb. of flour. The amylase levels are also preferably present at activity levels of at least about 3,000 MANU/kg of flour, more preferably from about 5,000 to about 30,000 MANU/kg of flour, and even more preferably from about 5,000 to about 10,000 MANU/kg of flour. As used herein, one MANU (Maltogenic Amylase Novo Unit) is defined as the amount of enzyme required to release one μmol of maltose per minute at a concentration of 10 mg of maltotriose (Sigma M 8378) substrate per ml of 0.1 M citrate buffer, pH 5.0 at 37° C. for 30 minutes.

Use of the maltogenic amylase at these high levels results in many significant advantages, as described herein. For example, utilizing the maltogenic amylase at these high levels allows for the quantity of other ingredients commonly used in the industry to be greatly reduced, and even more preferably eliminated, from the dough formulation. In one embodiment, dough strengtheners such as sodium stearoyl lactylate are included at levels of less than about 0.2% by weight, and even more preferably at about 0% by weight, based upon the total weight of the flour taken as 100% by weight. In a further embodiment, the dough comprises less than about 5 ppm azodicarbonamide, and even more preferably about 0 ppm azodicarbonamide, based upon the total weight of the flour. Even more preferably, the dough utilizes both the dough strengtheners and azodicarbonamide at these low (or non-existent) levels in conjunction with the high maltogenic amylase levels. In an even more preferred embodiment, the dough also has less than about 0.15% (and more preferably 0%) by weight of each of ethoxylaled monoglycerides, DATEM, calcium stearoyl lactylate, vinegar, and sodium stearoyl lactylate, and less than about 15 ppm (and more preferably 0 ppm) of each of potassium bromate, potassium iodate, azodicarbonamide, and calcium peroxide.

Advantageously, the high maltogenic amylase levels allow for a very low-sugar dough formulation that still results in a very sweet product, as described in more detail below. In this embodiment, the sugar levels in the dough are less than about 5% by weight sugar, more preferably less than about 4% by weight sugar, and even more preferably less than about 3% by weight sugar, based upon the total weight of the flour taken as 100% by weight.

In forming the dough according to the invention, the above ingredients can be simply mixed together in one stage using the “no-time dough process,” or they can be subjected to the “sponge and dough process.” In the latter process, part of the flour (e.g., 55-75% by weight of the total flour) is mixed with water, yeast, and preferably the dough strengthener (if utilized) and allowed to ferment for a time period of from about 3 hours to about 4 hours. This forms the “sponge.”

After this time period, the remaining ingredients are mixed with the sponge for a time period of from about 2 minutes to about 6 minutes. Advantageously, the maltogenic amylase can be provided as part of a “pre-mix” product that can be conveniently mixed with the sponge dough. A preferred such pre-mix comprises the maltogenic amylase, a diluent, a density-adjusting component, and a fat or oil. The amylase is preferably provided in the pre-mix at a level of from about 2% to about 10% by weight, and more preferably from about 4% to about 8% by weight, based upon the total weight of the pre-mix taken as 100% by weight.

The diluent is provided at levels of from about 60% to about 80% by weight, and more preferably from about 70% to about 80% by weight, based upon the total weight of the pre-mix taken as 100% by weight. Examples of suitable diluents include those selected from the group consisting of flour (e.g., wheat flour), starches, powdered emulsifiers, salt, sugar, flow agents, and mixtures thereof. The density-adjusting component is provided at levels of from about 15% to about 35% by weight, and more preferably from about 20% to about 28% by weight, based upon the total weight of the pre-mix taken as 100%) by weight. Examples of suitable density-adjusting components include those selected from the group consisting of calcium sulfate, salt, sugar, and mixtures thereof. The fat or oil is provided at levels of from about 0.01% to about 3% by weight, and more preferably from about 0.08%) to about 1.5% by weight, based upon the total weight of the pre-mix taken as 100% by weight. Examples of suitable fats and oils include those selected from the group consisting of vegetable oils (e.g., soybean oil), mineral oil, sunflower oil, cottonseed oil, and mixtures thereof.

Regardless of whether the remaining ingredients are mixed with the sponge individually or with the use of a pre-mix, the mixed dough is preferably allowed to rest for a time period of from about 5 minutes to about 15 minutes before being formed into the desired size pieces and placed in the baking pans. The dough is then preferably allowed to proof at a temperature of from about 40° C. to about 50° C. at a relative humidity of from about 65% to about 75% for a time period of from about 50 minutes to about 70 minutes. The product can then be baked using the times and temperatures necessary for the type of product being made (e.g., from about 190° C. to about 220° C. for about 20 minutes to about 30 minutes).

As mentioned above, the use of such high levels of maltogenic amylase results in a number of advantages, including significantly improved properties that are achieved in the final product. One significant improvement achieved is the flavor improvement. Another improvement is volume enhancement. That is, when a bakery product is formed according to the invention, the volume of the product containing the above ranges of maltogenic amylase will be at least about 3%, preferably at least about 4%, and even more preferably from about 5% to about 10% greater than the volume of an otherwise identical formulation but without the maltogenic amylase. When the product is bread, the specific volume is at least about 5.5 g/cc³, preferably at least about 6.0 g/cc³, and more preferably at least about 6.5 g/cc³, in a 454 g piece of bread. The volume is determined by the industry standard Rapeseed Displacement Test.

Bakery products formed according to the present invention also have improved compressibility values, which translates to improved shelf life. Thus, when subjected to the crumb compressibility stress described in Example 2, bakery products according to the invention will give results of less than about 150 g of force, preferably less than about 140 g of force, and even more preferably less than about 130 g of force. Furthermore, when subjected to the adhesiveness test described in Example 2, bakery products according to the invention will give a value of from about −5 g of force to about −25 g of force, and more preferably from about −10 g of force to about −20 g of force.

Finally, as mentioned above, the inventive method allows one to substantially reduce the sugar levels in the dough, thus avoiding the problems associated with sugar, yet still achieving a sweet product. Compared to prior art methods, the baked product will have more than double the total sugars level and will particularly have very high maltose levels. That is, the baked product will have maltose levels of at least about 5% by weight, preferably at least about 6% by weight, and more preferably at least about 8% by weight, based upon the total weight of the dried solids in the bakery product taken as 100% by weight. This is true even though the starting sugar levels are so low as described above. The maltose produced is confined to the interior of the product, which gives sweetness but does not affect crust color. Therefore, a number of changes to a typical formulation can be made as a result of the maltose production. Sugar can be decreased, water can be increased, yeast levels can be reduced, and dough strengtheners and other chemicals can be reduced or eliminated in some cases.

### EXAMPLES

The following examples set forth preferred methods in accordance with the invention. It is to be understood, however, that these examples are provided by way of illustration and nothing therein should be taken as a limitation upon the overall scope of the invention.

### Testing Methods

After baking, the bread was cooled to an internal temperature of 100° F. (50 minutes), then weighed, measured for volume, sealed in a 3 mil plastic bag (two loaves per bag), and stored in a temperature-controlled room at 72° F.±2° F. until 4 days after the day of bake. At that time, the loaves were sliced one set at a time with an Oliver 16 blade sheer to a thickness of 25 mm±2 mm to produce 10 slices per one pound loaf. The center four slices were tested using Texture Profile Analysis (TPA) procedure. The measuring instrument was a Texture Analyzer from Stable Micro Systems (TA-XT2 Texture Analyzer—25 kg load cell with 1 g resolution). The software running this instrument was Texture Expert Exceed version 2.64. The settings for running the TPA on the Texture Analyzer for bread were:

| Test Mode and Option | TPA |
|---|---|
| Pre-Test Speed (mm/sec) | 2.00 |
| Test Speed (mm/sec) | 5.00 |
| Post Test Speed (mm/sec) | 5.00 |
| Distance (depth of test in mm) | 15.0 |
| Trigger Type | Auto |
| Trigger Force (grams) | 20 |
| Stop Plot At | Trigger Return |
| Auto Tare | On |
| Units Force | Grams |
| Units Distance | Millimeters |

It will be appreciated that one skilled in the art would be able to adjust these settings based upon the type of product being tested. For example, the Distance (depth of test in mm) could be adjusted depending upon the type of product tested.

A TA-4 probe (½ inch-38 mm diameter acrylic cylinder) was used, and graph preferences were set to Time and auto range on the X axis, and Force and auto range on the Y axis.

The procedure for measuring the bread was to lay a single slice on the platform of the Texture Analyzer, position it so the probe was approximately in the center of the slice and about 10 mm above the surface, and start the test program. The test generated a graph that was used to quantify adhesiveness and compressibility. Specifically, the adhesiveness, or adhesive value, is the negative area following the end of the first curve and representing the force necessary to withdraw the probe from the slice. The compressibility is the force point on the first curve corresponding to a punch depth of 6.2 mm (25 mm slice×25% compression—from AACC Method 74-09).

### Example 1

### Flavor Improvement in Refrigerated Bread

### 1. Preparation of Bread

Bread stales most rapidly at temperatures close to 4° C. Impact on texture and flavor degradation is generally considered to be the worst under these conditions. A standard white pan bread formulation was prepared according to the following sponge and dough bread making process. The following ingredients were scaled into a 60-qt. mixing bowl that was fitted with a spiral dough hook: 9.46 lb. bread flour; 0.65 lb. compressed yeast; 0.07 lb. sodium stearoyl lactylate (SSL) (EMPLEX, obtained from Caravan Ingredients, Lenexa, Kans.); and 4.95 lb. of water at 21° C. These ingredients were mixed on first speed for one minute and then on second speed for two minutes in a standard 60-quart, three-speed, upright planetary mixer. This sponge was placed in greased dough troughs for fermentation. The dough troughs with the sponge were allowed to ferment in the fermentation cabinet at 28° C. with a relative humidity of 84.0% for three hours.

The following ingredients were then scaled into a 60-qt. mixing bowl: 5.09 lb. bread flour; 0.15 lb. non-fat dry milk; 0.29 lb. salt; 1.16 lb. sugar; 0.067 lb. calcium propionate; 0.29 lb GMS-90 (a 25% aqueous hydrated monoglyceride, obtained from Caravan Ingredients); 0.01 lb. DEPENDOX AXC (a dough conditioner, obtained from Caravan Ingredients); 0.29 lb. soy oil; 0.15 lb. compressed yeast; all of the sponge prepared above; and 3.35 lb. of water that was two-thirds by weight crushed ice. Control doughs contained no maltogenic amylase, while test doughs contained maltogenic amylase activity of either 10,000, 5,000, 2,000, 1,500, 1,000 or 0 MANU/kg of flour. The maltogenic amylase utilized was NOVAMYL, obtained from Novozymes A/S, Denmark. The enzyme utilized had an activity of 10,000 MANU/g of enzyme. This enzyme was added to the dough in the appropriate quantities per kg of flour to give the above activities (e.g., 1 g was added per kg of flour to give 10,000 MANU/kg of flour; 0.5 g was added per kg of flour to give 5,000 MANU/kg of flour).

The dough was mixed for 1 minute on first speed and then on third speed until full gluten development was reached (approximately 5 minutes). The dough was divided into pieces each weighing 525 g before being rounded by hand. The dough rested for 10 minutes, and then was sheeted and placed in greased bread pans. The dough was proofed at 44° C. and 75% relative humidity for 60 minutes. Bread was baked in a revolving tray oven at 216° C. for 20 minutes. The bread was then removed from the pans immediately after exiting the oven and allowed to cool on a wire rack for 50 minutes before being placed in airtight bags. The 1-day old fresh control bread and the 7-day old “stale control” were stored at 20° C. Bread with varying maltogenic amylase levels including the one with zero activity was stored between 3° C. and 4° C. until testing.

### 2. Testing of Bread

The bread prepared in Part 1 of this Example was subjected to testing. A total of 26, untrained panelists participated in the consumer study of white pan bread. Testing was administered on days one, fourteen, and twenty-eight with seven to eight samples per session. Bread samples were cut into two and one-half inch round disks that were one inch thick. These disks were then sealed in airtight bags and labeled with random three digit codes. All samples were presented at one time, and the sampling order was predetermined by the order listed on the evaluation sheets. By controlling the sampling order in a random manner, bias was eliminated. Unsalted crackers and distilled water were provided between samples. Panelists were instructed to use the crackers and water to cleanse their respective palates before tasting the samples and any other time during the test, if needed.

A randomized complete block design was used for setting up the consumer panel; each panelist tested each product in random order. Consumer Perceived Attribute and Acceptance testing were performed with a nine point hedonic scale with nine being the best score possible. All sensory attributes were analyzed using JMP statistical software. The analysis of variance (ANOVA) and least significant difference were used to determine statistical differences between samples.

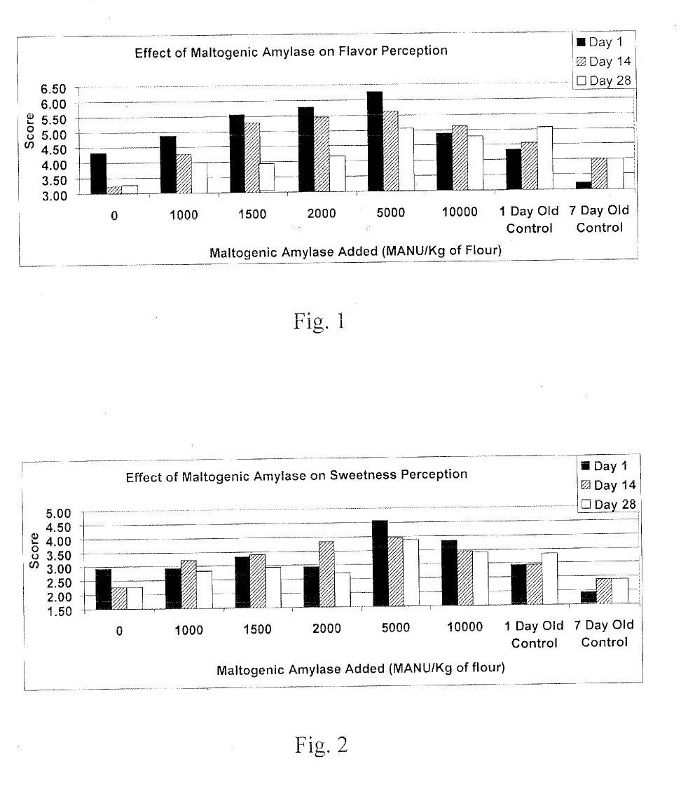

FIG. 1 shows the average flavor scores on various days. Flavor improved as the amount of maltogenic amylase added to the dough was increased. The addition of maltogenic amylase at the level of 5,000 MANU/kg of flour produced the best flavor. The 10,000 MANU/kg of flour level may have scored lower due to the impact of texture on flavor perception since this bread was considerably softer and moister. After 28 days of refrigeration the bread with 10,000 MANU/kg received the same score as the 1 day old control. The scores for the 7 day old control went up over time, probably due to comparative reasons as the other breads began getting lower scores.

FIG. 2 shows the effect of maltogenic amylase on perceived sweetness. Again, the highest sweetness scores were at the 5,000 MANU/kg of flour activity level. Sweetness scores were closely correlated with the amount of maltogenic amylase added. Again, the 10,000 MANU/kg level resulted in slightly lower scores than the 5,000 MANU/kg level. It is likely the soft crumb texture did not release sugar as quickly, resulting in lower perception of sweetness. The perception of sweetness decreased over time but the breads with high levels of maltogenic amylase remained much sweeter than the 1 day old control throughout the study.

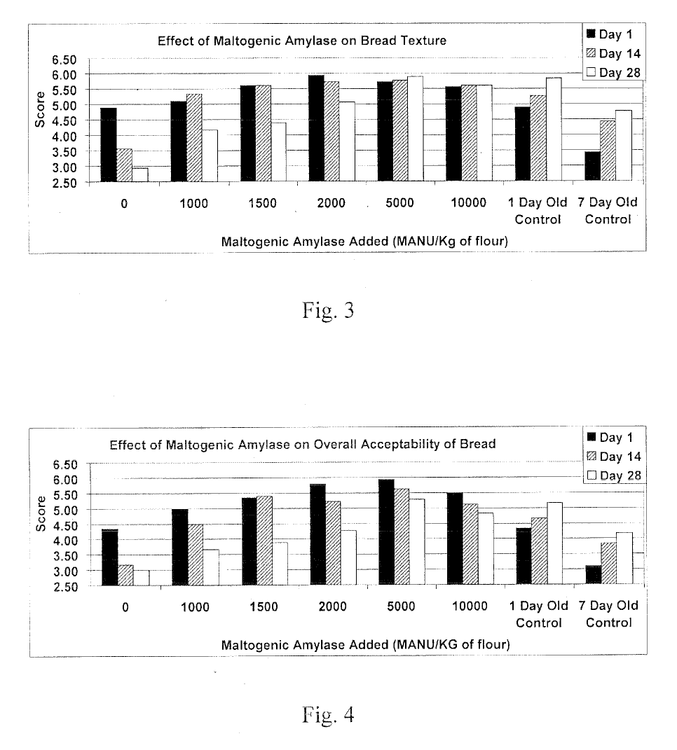

FIG. 3 shows the effect of maltogenic amylase on bread texture. As the amount of maltogenic amylase was increased, the texture of the bread improved up to the 5,000 MANU/kg of flour activity level, which was judged to be even better than the 1 day old control. The 1 day old control was very close in texture score to the 5,000 MANU/kg level on day 28. The texture scores for bread with higher levels of maltogenic amylase remained much more constant over the testing period in comparison to the lower levels or the controls.

The overall acceptability of white pan bread improved with the addition of maltogenic amylase. The bread with 5,000 MANU/kg of activity produced bread with consistently high scores for overall acceptability throughout the study, and at day 28 scored similarly to the 1 day old control. The 0% maltogenic amylase and non-refrigerated 7 day old control consistently received low scores.

### Example 2

### Bread Volume Improvement by High Maltogenic Amylase Levels

A test bake was conducted to show that sugar, yeast, soybean oil, and dough strengtheners can be reduced or eliminated, and that water can be increased with no negative side effects as a result of adding maltogenic amylase at 10,000 MANU/kg of flour. The bread was baked according to the procedure described in Example 1. All bread in this Example was stored at 20° C. before texture analysis on day 4 after baking. The bread was evaluated for final baked volume, softness, and crumb adhesiveness. The formulas used for each test are set forth in Table 2.

TABLE 2
Test Formulas

| INGREDIENT | CONTROL* | TEST 1 | TEST 2 | TEST 3 | TEST 4 | TEST 5 | TEST 6 | TEST 7 | TEST 8 | TEST 9 | TEST 10 | TEST 11 |
|---|---|---|---|---|---|---|---|---|---|---|---|---|
| Flour | 100 | 100 | 100 | 100 | 100 | 100 | 100 | 100 | 100 | 100 | 100 | 100 |
| Sugar | 8 | 6 | 4 | 4 | 4 | 4 | 4 | 4 | 4 | 8 | 8 | 4 |
| Sodium Stearoyl | 0.5 | 0.5 | 0.5 | 0.5 | 0.5 | 0.5 | 0.5 | 0 | 0 | 0.5 | 0.5 | 0 |
| Lactylate | | | | | | | | | | | | |
| Hydrated Monoglyceride | 2 | 2 | 2 | 2 | 2 | 2 | 2 | 2 | 2 | 2 | 2 | 2 |
| (GMS-90) | | | | | | | | | | | | |
| Salt | 2 | 2 | 2 | 2 | 2 | 2 | 2 | 2 | 2 | 2 | 2 | 2 |
| Non-fat Dry Milk | 1 | 1 | 1 | 1 | 1 | 1 | 1 | 1 | 1 | 1 | 1 | 1 |
| Soybean oil | 3 | 3 | 3 | 3 | 3 | 3 | 3 | 3 | 3 | 2 | 1 | 1 |
| Azodicarbonamide | 40 ppm | 40 ppm | 40 ppm | 40 ppm | 40 ppm | 40 ppm | 40 ppm | 40 ppm | 40 ppm | 40 ppm | 40 ppm | 40 ppm |
| Ascorbic Acid | 80 ppm | 80 ppm | 80 ppm | 80 ppm | 80 ppm | 80 ppm | 80 ppm | 80 ppm | 80 ppm | 80 ppm | 80 ppm | 80 ppm |
| Fungal Amylase | 45 FAU | 45 FAU | 45 FAU | 45 FAU | 45 FAU | 45 FAU | 45 FAU | 45 FAU | 45 FAU | 45 FAU | 45 FAU | 45 FAU |
| Yeast | 4.5 | 4.5 | 4.5 | 3.5 | 2.5 | 3.5 | 3.5 | 3.5 | 3.5 | 4.5 | 4.5 | 3.5 |
| Water | 59 | 59 | 59 | 59 | 59 | 61 | 63 | 59 | 61 | 59 | 59 | 63 |
| Maltogenic Amylase | 0 MANU | 1,000 | 1,000 | 1,000 | 1,000 | 1,000 | 1,000 | 1,000 | 1,000 | 1,000 | 1,000 | 1,000 |
| | | MANU | MANU | MANU | MANU | MANU | MANU | MANU | MANU | MANU | MANU | MANU |

*All weights are pounds based upon 100 lb. of flour; ppm measurements are based upon the weight of the flour; and MANUs and FAUs were based on 1 kg of flour.

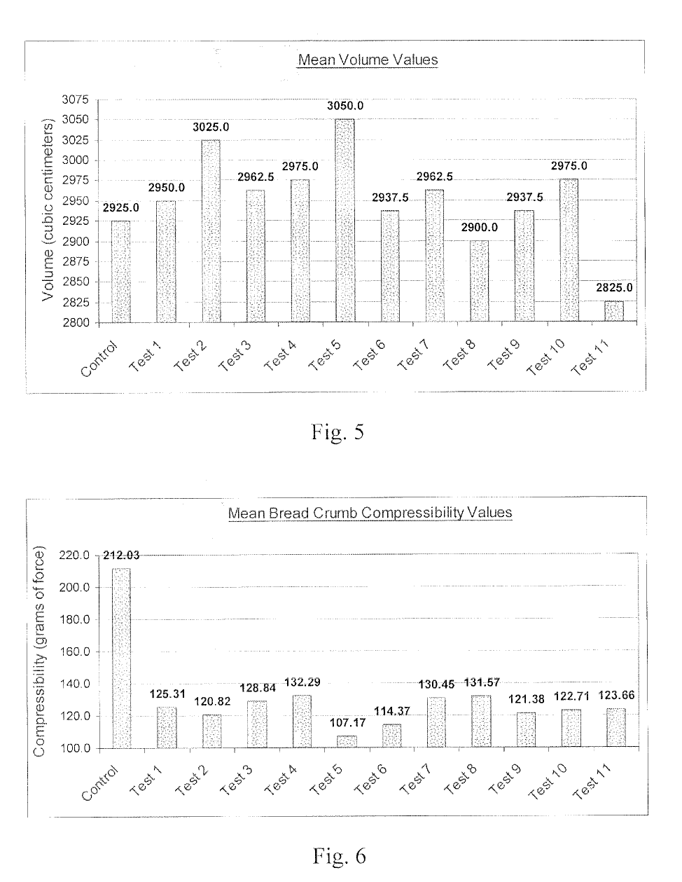

FIG. 5 is a graph showing the final baked volumes for the control and test breads. Volume was determined using the industry standard Rapeseed Displacement Test. A volume difference of 150 cubic centimeters (cc), or roughly 5% of total loaf volume, is considered significant. Therefore, none of the tests differed significantly from the control in terms of volume. In addition, only test 4 and test 10 took significantly longer to proof than the control (see Table 3). Therefore, the majority of the changes either had no impact on proof time or proofed faster, which is desirable. Bread shape and crumb grain were judged to be similar for all breads with the exception of Test 4, which resulted in some misshapen loaves. This was considered to be due to the combination of too low of a yeast level with reduced sugar.

TABLE 3
Effect of Various Formulations on Proof Time

| | PROOF TIME |
|---|---|
| SAMPLE | (MINUTES) |
| Control | 57 |
| Test 1 | 54 |
| Test 2 | 51 |
| Test 3 | 55 |
| Test 4 | 62 |
| Test 5 | 58 |
| Test 6 | 57 |
| Test 7 | 55 |
| Test 8 | 55 |
| Test 9 | 57 |
| Test 10 | 60 |
| Test 11 | 56 |

FIG. 6 shows the crumb compressibility values after four days for the various tests. A difference of about 20 grams of force, which equates roughly to one day of shelf life, is considered to be significant in this test. Therefore, all of the tests were significantly softer than the control.

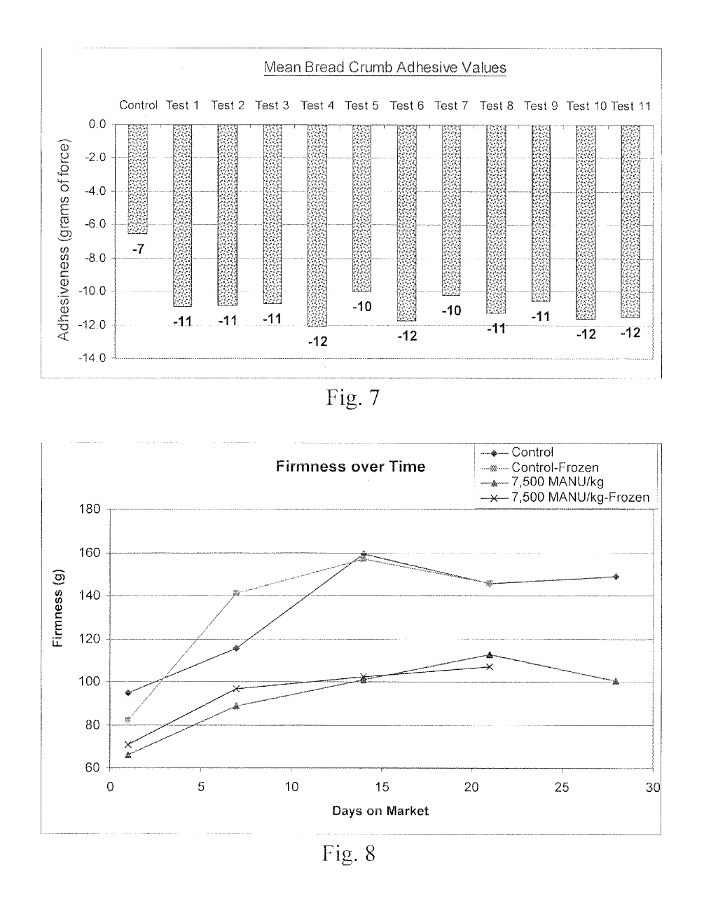

FIG. 7 shows the impact of the various tests on adhesiveness after four days, which is a measure of the degree of stickiness of the bread crumb. Bread with adhesive values in the range up to −5 is considered to be dry. Bread with an adhesive value above approximately −25 is considered to be overly sticky or gummy. Adhesive values between about −5 and about −25 are considered acceptable according to personal taste. Therefore, the control and all test formulas produced bread with acceptable adhesiveness values.

### Example 3

### Production of High Maltose Levels in Baked Bread Using Maltogenic Amylase

Bread was made according to the formula and procedure described in Example 1. The control contained no maltogenic amylase, and the test contained 10,000 MANU/kg of flour (again, NOVAMYL). The bread was analyzed for sugar content, and those results are shown in Table 4.

TABLE 4
Effect of Maltogenic Amylase on Sugar Level in Baked Bread

| TYPE | | |
|---|---|---|
| OF SUGAR | WEIGHT % - CONTROL* | WEIGHT % - TEST 1* |
| Maltose | 0.48 | 5.37** |
| Fructose | 2.04 | 1.99 |
| Sucrose | 0 | 0 |
| Glucose | 0 | 0 |
| Lactose | 0 | 0 |
| Total Sugars | 2.52 | 7.36 |
| Fructose Basis | 2.28 | 4.67 |

*Based upon the total weight of the bread.
**Translates to about 8.66% maltose on a dried solids basis.

The starling formulations for the control and Test 1 contained the same amount of sugar. However, after baking, Test 1 contained nearly three times as much total sugars as the Control and was judged to be significantly sweeter. On a fructose sweetness basis, considering fructose is approximately three times as sweet as maltose, Test 1 was nearly 2 times as sweet as the control.

### Example 4

A field trial was conducted to determine if high levels of maltogenic amylase could replace various dough conditioners. The control formula was a commercial hot dog bun formula containing Do Crest 60 (60% ethoxylated monoglycerides, obtained from Caravan Ingredients), (GMS 90 Double Strength hydrated monoglycerides, obtained from Caravan Ingredients), ER200 enzyme (obtained from Lallemand, Rexdale, Ontario), PBR 2000 enzyme (obtained from Lallemand), 30 ppm azodicarbonamide, and FB Bun Soft 3 (obtained from Danisco, New Century, Kans.) which is a commercial enzyme shelf life extender (see Table 5). The test sample contained maltogenic amylase (obtained from Novozymes A/S) at a level of 7,500 MANU/kg of flour, but there was no addition of ethoxylated monoglycerides, ER 200, azodicarbonamide, or FB Bun Soft 3. Table 5 shows the changes that were made in the test formulation relative to the control.

TABLE 5

| INGREDIENT | CONTROL* | TEST |
|---|---|---|
| Do Crest 60 | 375% | 0% |
| GMS 90 | 1% | 1% |
| ER 200 | 1 oz. | 0 |
| PBR 2000 | 25 oz. | 25 oz. |
| azodicarbonamide (20 ppm) | 1.5 tab | 0 |
| FB Bun Soft 3 | 1 tab | 0 |

*Weight percentages are based on flour.

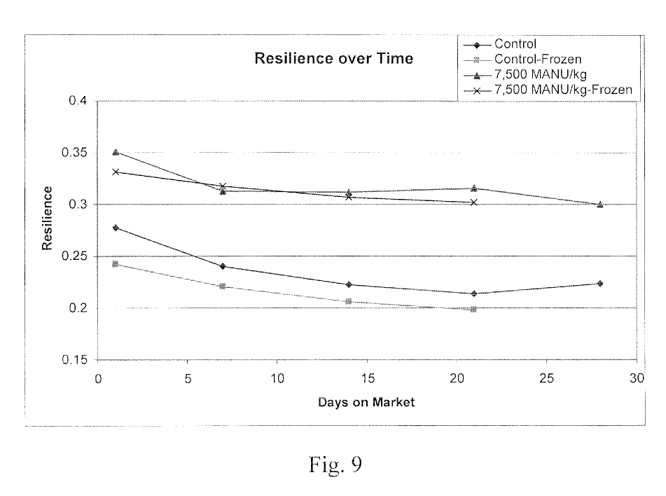

Even though the Do Crest 60, ER 200, ADA, and FB Bun Soft 3 were removed, the test dough received the same dough mixing time and handling conditions as the control. The test dough handled well and had similar properties in comparison to the control throughout processing. The final baked product also had equivalent volume, crumb cell structure, and overall outward appearance to the control. The test bread was, however, considerably softer than the control bread (see FIG. 8) when stored at ambient conditions or under frozen conditions. The test bread was also considerably more resilient than the control dough (see FIG. 9).

### Example 5

The control of Example 4 was tested to determine its maltose and total sugar levels. The maltose level was 2.40%, while the total sugar level was 6.23%, both on a total sample weight basis. The control was altered to replace the FB Bun Soft 3 with Novamyl® (7,500 MANU Novamyl/kg flour). All other ingredients and baking conditions were identical between the control and the test sample. The maltose and total sugar levels were tested in this sample as well, and those values were 6.03% and 9.69%, respectively, both on a total sample weight basis. Thus, the test sample had about 2½ times the maltose levels as the control sample, and 50% more total sugars.

We claim:

1. A method of forming a yeast-raised or other bakery product, said method comprising:
providing dough comprising:
flour;
less than about 5% by weight sugar, based upon the total weight of the flour taken as 100% by weight; and
a maltogenic amylase; and
baking the dough for a time and temperature sufficient to yield the bakery product, said product having a final quantity of maltose being at least about 5% of the dried solids in the bakery product.

2. The method of claim 1, wherein said maltogenic amylase is present at levels of at least about 3,000 MANU/kg of flour.

3. The method of claim 1, wherein said maltogenic amylase is present at levels of at least about 500 ppm, based upon 100 lb of flour.

4. The method of claim 1, said final quantity of maltose being at least about 6% of the dried solids in the bakery product.

5. The method of claim 1, further comprising proofing said dough prior to baking.

6. The method of claim 1, wherein said dough further comprises yeast, a dough strengthener, a mold inhibitor, an oil or fat, a flour improver, azodicarbonamide, an emulsifier, and water.

7. The method of claim 1, wherein said dough comprises:
less than about 0.2% by weight dough strengthened based upon the total weight of the flour taken as 100% by weight; and
about 0 ppm azodicarbonamide.

8. The method of claim 1, wherein said product will yield a crumb compressibility stress result of less than about 150 g of force.

9. The method of claim 1, wherein said product will yield an adhesive value of from about −5 g of force to about −25 g of force.

10. The method of claim 1, wherein said product is bread, and the specific volume of said bread is at least about 5.5 g/cc³ in a 454 g piece of bread.

11. The method of claim 1, wherein said maltogenic amylase is produced by Bacillus strain NCIB 11837 or is encoded by a DNA sequence derived from Bacillus strain NCIB 11837.

12. In a dough useful for forming a yeast-raised bakery product and comprising flour, yeast, and water, the improvement being that said dough comprises:
less than about 5% by weight sugar, based upon the total weight of the flour taken as 100% by weight; and
a maltogenic amylase at levels of at least about 3,000 MANU/kg of flour.

13. The dough of claim 12, said dough comprising less than about 0.15% by weight of each of the following: ethoxylated monoglycerides, DATEM, calcium stearoyl lactylate, vinegar, and sodium stearoyl lactylate, based upon the total weight of the flour taken as 100% by weight.

14. The dough of claim 12, said dough comprising less than about 15 ppm, based upon the weight of the flour, of each of the following: potassium bromate, potassium iodate, azodicarbonamide, and calcium peroxide.

15. The dough of claim 12, wherein said maltogenic amylase is produced by Bacillus strain NCIB 11837 or is encoded by a DNA sequence derived from Bacillus strain NCIB 11837.

16. In a yeast-raised bakery product formed from flour, yeast, and water, the improvement being that said product comprises:
at least about 500 ppm, based upon the weight of the flour, inactivated maltogenic amylase; and
at least about 5% by weight maltose, based upon the weight of the dried solids in the bakery product.

17. The product of claim 16, said product comprising less than about 0.15% by weight of each of the following: ethoxylated monoglycerides, DATEM, calcium stearoyl lactylate, and sodium stearoyl lactylate, based upon the total weight of the flour taken as 100% by weight.

18. The product of claim 16, wherein said product will yield a crumb compressibility stress result of less than about 150 g of force.

19. The product of claim 16, wherein said product will yield an adhesive value of from about −5 g of force to about −25 g of force.

20. The product of claim 16, wherein said product is bread, and the specific volume of said bread is al least about 5.5 g/cc³ in a 454 g piece of bread.

21. The product of claim 16, wherein said maltogenic amylase is produced by Bacillus strain NCIB 11837 or is encoded by a DNA sequence derived from Bacillus strain NCIB 11837.

22. In a dough useful for forming a yeast-raised bakery product and comprising flour, yeast, and water, the improvement being that said dough comprises:
less than about 0.15% by weight of each of the following: ethoxylated monoglycerides, DATEM, calcium stearoyl lactylate, and sodium stearoyl lactylate, based upon the total weight of the flour taken as 100% by weight;
less than about 15 ppm, based upon the weight of the flour, of each of the following:
potassium bromate, potassium iodate, azodicarbonamide, and calcium peroxide; and
a maltogenic amylase at levels of at least about 3,000 MANU/kg of flour.

23. The dough of claim 22, wherein said maltogenic amylase is produced by Bacillus strain NCIB 11837 or is encoded by a DNA sequence derived from Bacillus strain NCIB 11837.
